(19) United States
(12) Patent Application Publication
(10) Pub. No.: US 2024/0219583 A1
(43) Pub. Date: Jul. 4, 2024

(54) LOCATION DETERMINATION USING A PLURALITY OF GEO-LOCATION TECHNIQUES

(71) Applicant: Meta Platforms Technologies, LLC, Menlo Park, CA (US)

(72) Inventors: Scott SHILL, Plano, TX (US); Tony DAVID, San Jose, CA (US); Kirk Erik BURGESS, Newark, CA (US)

(73) Assignee: Meta Platforms Technologies, LLC, Menlo Park, CA (US)

(21) Appl. No.: 18/390,856

(22) Filed: Dec. 20, 2023

Related U.S. Application Data
(60) Provisional application No. 63/435,726, filed on Dec. 28, 2022.

(51) Int. Cl. G01S 19/48; G01S 19/49

(52) U.S. Cl. CPC G01S 19/485; G01S 19/49

(57) ABSTRACT

According to examples, a system for determining a location using a plurality of geo-location techniques is described. The system may include a processor and a memory storing instructions. The processor, when executing the instructions, may cause the system to receive sensor data associated with the location, receive image information associated with the location, analyze the image information associated with the location, and provide a localization and mapping analysis for the location. The processor, when executing the instructions, may then determine an analyzed list of features and a primary landmark associated with the location, and determine location information for the location based on the analyzed list of features and the primary landmark.

### PRIORITY

This patent application claims priority to U.S. Provisional Patent Application No. 63/435,726, entitled “Location Determination Using a Plurality of Geo-location Techniques,” filed on Dec. 28, 2022.

### TECHNICAL FIELD

This patent application relates generally to navigation and mapping, and more specifically, to systems and methods for determining a location using a plurality of geo-location techniques.

### BACKGROUND

An application on a user device (e.g., a smartphone) may include functionalities that may utilize or provide location information. One such example may be a mapping application. Another example may be a social application, which may enable a user to “tag” a content item with location information.

In some instances, a user device may determine location information utilizing a microchip associated with a global navigation satellite system (GNSS), such as global positioning system (GPS). However, in some instances, issues may arise that may make location determination difficult.

One such issue may be transmission integrity. In some instances, it may be difficult to send or to receive a wireless signal (e.g., from inside a building or when traveling through a tunnel). In these instances, solely using global navigation satellite system (GNSS) data may result in an imprecise location determination.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIGS. 1A-1C illustrate various aspects of a system environment, including a system, for determining a location using a plurality of geo-location techniques, according to an example.

FIG. 2 illustrates a block diagram of a computer system for determining a location using a plurality of geo-location techniques, according to an example.

FIG. 3 illustrates a flow diagram of a method for determining a location using a plurality of geo-location techniques, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

In some instances, a typical consumer electronic device (e.g., a smartphone) may include a microchip associated with a global navigation satellite system (GNSS), such as global positioning system (GPS), that may provide location information. As used herein, “location information” may include any information that may be associated with a location or may be utilized to determine a location. Examples of such information may include image information, navigation information, and contextual information associated with the location. In some instances, an amount of time required to determine a location for the user device may be referred to as a “time to fix.”

A global navigation satellite system (GNSS) location may be useful in many contexts. For example, in some instances, a user of social application may wish to “tag” a content item (e.g., an image, a video) with location information. However, in some instances, various issues may make location determination difficult.

One such issue may be power consumption. In some examples, continuously transmitting and receiving wireless signals, as may be required to ascertain location information of a user device, may require a significant commitment of the user device's power supply. In such instances, the user device's performance may be adversely impacted.

Another issue may be transmission integrity. Specifically, in some instances, transmitting and receiving of wireless signals in urban areas (e.g., from inside of a building or while traveling through a tunnel) and in rural areas (e.g., where signal strength may be minimal) may present difficulties.

By way of example, in some instances, a user of a social application may wish to tag an image of a particular location (e.g., a particular shop in a mall). In some examples, utilizing (only) global positioning system (GPS) data may result in an imprecise tag. In particular, in some examples, the tag may correspond only to a general location (e.g., a group of buildings of a mall or an area of land associated with a mall), instead of a particular location (e.g., the particular shop in the mall).

In some examples, the systems and methods described may provide location determination using a plurality of geo-location techniques. As used herein, a “geo-location technique” (otherwise “technique” or “location technique”) may include any process, activity, or information (e.g., data) that may be associated with determining a location (e.g., of an object). In some instances, and as will be described further below, utilization of these various geo-location techniques may be referred to as a “full sensor” approach.

A first such technique may include utilization of a global navigation satellite system (GNSS). One example of a global navigation satellite system (GNSS) may be global positioning system (GPS). As used herein, the terms “global navigation satellite system (GNSS)” and “global positioning system (GPS)” may be used interchangeably in certain contexts. In some examples and as will be discussed in further detail below, the systems and methods described may utilize global navigation satellite system (GNSS) data to determine a location.

Another technique may be simultaneous localization and mapping (SLAM). In some examples, simultaneous localization and mapping (SLAM) may include, among other things, constructing and/or updating a map of a particular environment while simultaneously determining a location of an agent (e.g., a user device) within the environment.

Yet another technique may include implementation of an inertial measurement units (IMUs). In some examples, an inertial measurement unit (IMU) may be an electronic device or component that may measure and provide various information associated with an object (e.g., a user device). For example, this various information may include the object's specific force, angular rate, and orientation. In some examples, the inertial measurement unit (IMU) may include one or more of an accelerometer, a gyroscope, and a magnetometer.

In some examples, the systems and methods described may combine various types of information (e.g., concurrently or sequentially) originating from one or more components (e.g., sensors) to determine a location. So, in one example where a social application user may be located inside of a building and may wish to tag a particular location inside the building, the systems and methods may utilize, in combination, a first information (e.g., gyroscope information), a second information (e.g., global positioning system (GPS) data), and a third information (e.g., magnetometer information) to determine the particular location inside a building.

In some examples, the systems and methods may also gather and analyze image information associated with a location. So, for example, in some instances, the systems and methods may receive image information from a user device (e.g., having a camera), and may implement one or more image processing techniques to determine one or more aspects, characteristics, and features associated with the location. For example, in some instances, the systems and methods described may analyze image information to determine a point-of-view (POV) associated with the image information. More specifically, in some examples, since a user's point-of-view (POV) may face in a direction of a captured image gathered by a device (e.g., a smartphone) camera, the point-of-view (POV) associated with the captured image may be analyzed to determine an associated heading, which may then be utilized to determine the location.

In addition, in some examples, the systems and methods described may process one or more types of information with respect to a database of information. For example, in some examples, an existing database of information may include various information (e.g., images, sensor data, etc.) associated with one or more locations. In some examples, the systems and methods may compare the one or more types of (e.g., incoming) information with respect to the existing database of information (e.g., location image data for one or more locations) to determine a particular location.

In some examples, the systems and methods described may combine (e.g., concurrently or sequentially) a plurality of techniques described herein to determine a location. So, in some examples, the systems and methods may combine a first technique (e.g., use of a global navigation satellite system (GNSS)), a second technique (e.g., inertial measurement unit (IMU) data), and a third technique (e.g., image processing) to determine the location.

Accordingly, in some examples, the systems and methods described may utilize one or more types of information along with one or more techniques to determine a location for an object. Moreover, it may be appreciated that these one or more types of information or one or more techniques may be implemented according to a circumstance and/or setting, and may be implemented to maximize accuracy of location determination.

So, by way of example and as will be described further below, to determine a location, the systems and methods may receive and analyze global navigation satellite system (GNSS) data and inertial measurement unit (IMU) data. In addition, in some examples, to determine the location, the systems and methods may receive and analyze one or more images to determine features associated with the location, and further may compare these features to those features found in known locations (e.g., in a database of mapping information).

In some examples, systems and methods as described may include a processor and a memory storing instructions, which when executed by the processor, may cause the processor to, among other things, receive global navigation satellite system (GNSS) data associated with a location, receive sensor data associated with the location, receive image information associated with the location, and analyze the image information associated with the location. In addition, the instructions, when executed by the processor, may provide a localization and mapping analysis for the location, determine an analyzed list of features and a primary landmark associated with the location, and determine location information for the location based on the analyzed list of features and the primary landmark.

In some examples, the systems and methods include a method of determining a location using a plurality of geo-location techniques, comprising receiving sensor data associated with the location, receiving image information associated with the location, analyzing the image information associated with the location, and providing a localization and mapping analysis for the location. In addition, the method may include determining an analyzed list of features and a primary landmark associated with the location, and determining location information for the location based on the analyzed list of features and the primary landmark.

In some examples, the systems and methods may provide a non-transitory computer-readable storage medium having an executable stored thereon, which when executed instructs a processor to, among other things, receive global navigation satellite system (GNSS) data associated with a location, receive sensor data associated with the location, receive image information associated with the location, analyze the image information associated with the location, provide a localization and mapping analysis for the location, determine an analyzed list of features and a primary landmark associated with the location, and determine location information for the location based on the analyzed list of features and the primary landmark.

As discussed above, in some examples, the systems and methods may gather and utilize information (e.g., data) associated with a user or a user device to provide location determination. In some examples, the information associated with the user may be gathered and utilized according to various policies. For example, in particular embodiments, privacy settings may allow users to review and control, via opt in or opt out selections, as appropriate, how their data may be collected, used, stored, shared, or deleted by the systems and methods or by other entities (e.g., other users or third-party systems), and for a particular purpose. The systems and methods may present users with an interface indicating what data is being collected, used, stored, or shared by the systems and methods described (or other entities), and for what purpose. Furthermore, the systems and methods may present users with an interface indicating how such data may be collected, used, stored, or shared by particular processes of the systems and methods or other processes (e.g., internal research, advertising algorithms, machine-learning algorithms). In some examples, a user may have to provide prior authorization before the systems and methods may collect, use, store, share, or delete data associated with the user for any purpose.

Moreover, in particular embodiments, privacy policies may limit the types of data that may be collected, used, or shared by particular processes of the systems and methods for a particular purpose. In some examples, the systems and methods may present users with an interface indicating the particular purpose for which data is being collected, used, or shared. In some examples, the privacy policies may ensure that only necessary and relevant data may be collected, used, or shared for the particular purpose, and may prevent such data from being collected, used, or shared for unauthorized purposes.

Also, in some examples, the collection, usage, storage, and sharing of any data may be subject to data minimization policies, which may limit how such data that may be collected, used, stored, or shared by the systems and methods, other entities (e.g., other users or third-party systems), or particular processes (e.g., internal research, advertising algorithms, machine-learning algorithms) for a particular purpose. In some examples, the data minimization policies may ensure that only relevant and necessary data may be accessed by such entities or processes for such purposes.

In addition, it should be appreciated that in some examples, the deletion of any data may be subject to data retention policies, which may limit the duration such data that may be user or stored by the systems and methods (or by other entities), or by particular processes (e.g., internal research, advertising algorithms, machine-learning algorithms) for a particular purpose before being automatically deleted, de-identified, or otherwise made inaccessible. In some examples, the data retention policies may ensure that data may be accessed by such entities or processes only for the duration it is relevant and necessary. In particular examples, privacy settings may allow users to review any of their data stored by the systems and methods or other entities (e.g., third-party systems) for any purpose, and delete such data when requested by the user.

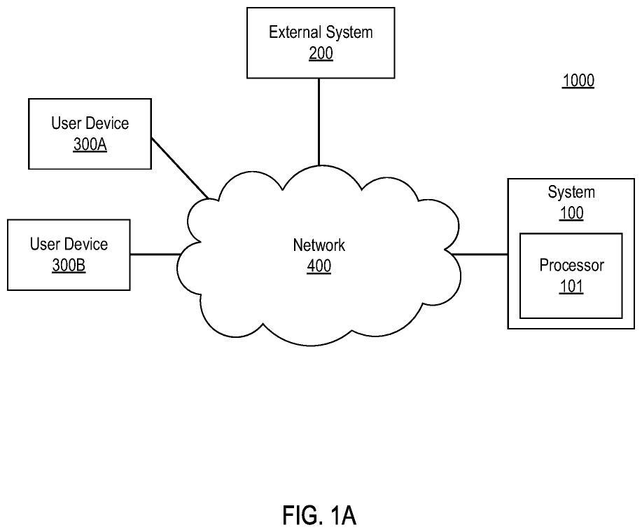

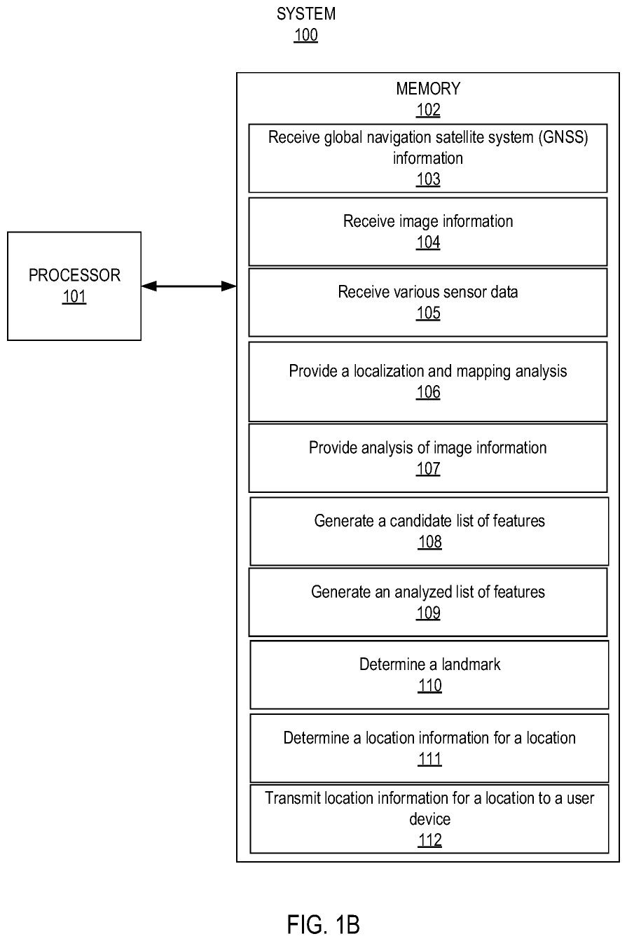

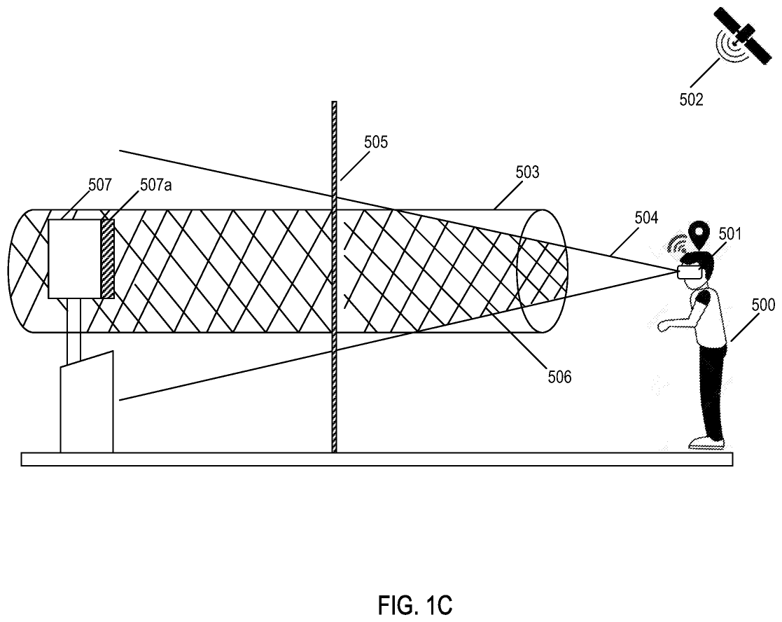

Reference is now made to FIGS. 1A-1C. FIG. 1A illustrates a block diagram of a system environment, including a system, that may be implemented for determining a location using a plurality of geo-location techniques, according to an example. FIG. 1B illustrates a block diagram of the system that may be implemented for determining a location using a plurality of geo-location techniques, according to an example. FIG. 1C illustrates a diagram of various aspects of a system environment that may be implemented for determining a location using a plurality of geo-location techniques, according to an example.

As will be described in the examples below, one or more of system 100, external system 200, user devices 300A-300B and system environment 1000 shown in FIGS. 1A-1B may be operated by a service provider to determine a location using a plurality of geo-location techniques. It should be appreciated that one or more of the system 100, the external system 200, the user devices 300A-300B and the system environment 1000 depicted in FIGS. 1A-1B may be provided as examples. Thus, one or more of the system 100, the external system 200 the user devices 300A-300B and the system environment 1000 may or may not include additional features and some of the features described herein may be removed and/or modified without departing from the scopes of the system 100, the external system 200, the user devices 300A-300B and the system environment 1000 outlined herein. Moreover, in some examples, the system 100, the external system 200, and/or the user devices 300A-300B may be or associated with a social networking system, a content sharing network, an advertisement system, an online system, and/or any other system that facilitates any variety of digital content in personal, social, commercial, financial, and/or enterprise environments.

While the servers, systems, subsystems, and/or other computing devices shown in FIGS. 1A-1B may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 100, the external system 200, the user devices 300A-300B or the system environment 1000.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of potentially personal, private, or sensitive data or information. These and other benefits will be apparent in the descriptions provided herein.

In some examples, the external system 200 may include any number of servers, hosts, systems, and/or databases that store data to be accessed by the system 100, the user devices 300A-300B, and/or other network elements (not shown) in the system environment 1000. In addition, in some examples, the servers, hosts, systems, and/or databases of the external system 200 may include one or more storage mediums storing any data. In some examples, and as will be discussed further below, the external system 200 may be utilized to store any information that may relate to determining a location using a plurality of geo-location techniques. As will be discussed further below, in other examples, the external system 200 may be utilized by a service provider (e.g., a social media application provider) as part of a data storage.

In some examples, and as will be described in further detail below, the user devices 300A-300B may be utilized to, among other things, determine a location using a plurality of geo-location techniques. In some examples, the user devices 300A-300B may be electronic or computing devices to transmit and/or receive data. In this regard, each of the user devices 300A-300B may be any device having computer functionality, such as a television, a radio, a smartphone, a tablet, a laptop, a watch, a desktop, a server, or other computing or entertainment device or appliance. In some examples, the user devices 300A-300B may be mobile devices that are communicatively coupled to the network 400 and enabled to interact with various network elements over the network 400. In some examples, the user devices 300A-300B may execute an application allowing a user of the user devices 300A-300B to interact with various network elements on the network 400. Additionally, the user devices 300A-300B may execute a browser or application to enable interaction between the user devices 300A-300B and the system 100 via the network 400.

Moreover, in some examples and as will also be discussed further below, the user devices 300A-300B may be utilized by a user operating a social application provided by a service provider, wherein information relating to the user may be stored and transmitted by the user devices 300A to other devices, such as the external system 200.

The system environment 1000 may also include the network 400. In operation, one or more of the system 100, the external system 200 and the user devices 300A-300B may communicate with one or more of the other devices via the network 400. The network 400 may be a local area network (LAN), a wide area network (WAN), the Internet, a cellular network, a cable network, a satellite network, or other network that facilitates communication between, the system 100, the external system 200, the user devices 300A-300B and/or any other system, component, or device connected to the network 400. The network 400 may further include one, or any number, of the exemplary types of networks mentioned above operating as a stand-alone network or in cooperation with each other. For example, the network 400 may utilize one or more protocols of one or more clients or servers to which they are communicatively coupled. The network 400 may facilitate transmission of data according to a transmission protocol of any of the devices and/or systems in the network 400. Although the network 400 is depicted as a single network in the system environment 1000 of FIG. 1A, it should be appreciated that, in some examples, the network 400 may include a plurality of interconnected networks as well.

In some examples, and as will be discussed further below, the system 100 may provide determining a location using a plurality of geo-location techniques. Details of the system 100 and its operation within the system environment 1000 will be described in more detail below.

As shown in FIGS. 1A-1B, the system 100 may include processor 101 and the memory 102. In some examples, the processor 101 may execute the machine-readable instructions stored in the memory 102. It should be appreciated that the processor 101 may be a semiconductor-based microprocessor, a central processing unit (CPU), an application specific integrated circuit (ASIC), a field-programmable gate array (FPGA), and/or other suitable hardware device.

In some examples, the memory 102 may have stored thereon machine-readable instructions (which may also be termed computer-readable instructions) that the processor 101 may execute. The memory 102 may be an electronic, magnetic, optical, or other physical storage device that contains or stores executable instructions. The memory 102 may be, for example, random access memory (RAM), an Electrically Erasable Programmable Read-Only Memory (EEPROM), a storage device, an optical disc, or the like. The memory 102, which may also be referred to as a computer-readable storage medium, may be a non-transitory machine-readable storage medium, where the term “non-transitory” does not encompass transitory propagating signals. It should be appreciated that the memory 102 depicted in FIGS. 1A-1B may be provided as an example. Thus, the memory 102 may or may not include additional features, and some of the features described herein may be removed and/or modified without departing from the scope of the memory 102 outlined herein.

It should be appreciated that, and as described further below, the processing performed via the instructions on the memory 102 may or may not be performed, in part or in total, with the aid of other information and data, such as information and data provided by the external system 200 and/or the user devices 300A-300B. Moreover, and as described further below, it should be appreciated that the processing performed via the instructions on the memory 102 may or may not be performed, in part or in total, with the aid of or in addition to processing provided by other devices, including for example, the external system 200 and/or the user devices 300A-300B.

In some examples, the memory 102 may store instructions, which when executed by the processor 101, may cause the processor to (among other things): receive global navigation satellite system (GNSS) data associated with a location, receive image information, gather various sensor data, initiate a localization and mapping analysis, and provide image analysis of image information. In addition, the instructions, which when executed by the processor 101, may further cause the processor to: generate a candidate list of features, generate an analyzed list of features, determine a landmark associated with a location, determine location information for a location, and transmit location information to receiving device.

In some examples, and as discussed further below, the instructions 103-112 on the memory 102 may be executed alone or in combination by the processor 101 to determine a location using a plurality of geo-location techniques. In some examples, the instructions 103-112 may be implemented in association with a content platform to provide content for users, while in other examples, the instructions 103-112 may be implemented as part of a stand-alone application.

Additionally, and as discussed further below, although not depicted, it should be appreciated that to determine a location using a plurality of geo-location techniques, the instructions 103-112 may utilize various artificial intelligence (AI) and machine learning (ML) based tools. For instance, these artificial intelligence (AI) and machine learning (ML) based tools may be used to generate models that may include a neural network (e.g., a recurrent neural network (RNN)), natural language processing (NLP), a generative adversarial network (GAN), a tree-based model, a Bayesian network, a support vector, clustering, a kernel method, a spline, a knowledge graph, or an ensemble of one or more of these and other techniques. It should also be appreciated that the system 100 may provide other types of machine learning (ML) approaches as well, such as reinforcement learning, feature learning, anomaly detection, etc.

In some examples, the instructions 103 may receive global navigation satellite system (GNSS) information. In some examples, global navigation satellite system (GNSS) data may be associated with a location. In some examples, the global navigation (GNSS) data may be provided by a user device (e.g., a smartphone) that may be located at or near the location. So, in some examples and as shown in FIG. 1C, the instructions 103 may receive global navigation satellite system (GNSS) data transmitted from a user device 501 operated by a user 500 via the satellite 502. In some examples, the user device 501 may be an augmented reality (AR)/virtual reality (VR) eyeglasses worn by a user participating in a guided tour, and the global navigation satellite system (GNSS) data may be global positioning system (GPS) data.

In some examples, the global positioning system (GPS) data received via the instructions 103 may be utilized to determine (e.g., construct) a (first) spatial representation. That is, in some examples, the global positioning system (GPS) data received may be utilized by the instructions 103 to generate a digital representation of a spatial area or volume that may be associated with a location to be determined.

So, in some examples, and as shown in FIG. 1C, the global navigation satellite system (GNSS) data received via the instructions 103 may be utilized to generate a spatial representation 503. In these examples, the spatial representation 503 may be cylindrical in shape. It may be appreciated that a spatial representation as generated via the instructions 103 may be of any shape, including but not limited to, cylinder, square, cube, rectangular, etc.

In some examples, the instructions 104 may receive image information associated with a location. So, in some examples, the instructions 104 may receive the image information from a user device (e.g., a smartphone) having a camera.

In some examples, image information received via the instructions 104 may be utilized to determine a (second) spatial representation. That is, in some examples, the image information received via the instructions 104 may be utilized to generate (e.g., construct) a digital representation of a spatial area or volume that may be associated with a location to be determined.

So, in some examples, and as shown in FIG. 1C, the image information received via the instructions 104 may be utilized to generate a spatial representation 504. In these examples, the spatial representation 504 may take a shape of a cone, or a “viewing cone.” It may be appreciated that a spatial representation as generated via the instructions 104 may be of any shape. In some examples, instead of a “viewing cone,” the instructions 104 may generate a spatial representation in shape of a frustum, or a “viewing frustum.”

In some examples, the instructions 104 may analyze image information to determine a viewing plane. In some examples, a camera (e.g., on a user device) may capture images that may be associated with a particular viewing plane. So, in some examples and as shown in FIG. 1C, the image information received via the instructions 104 may be utilized to determine a viewing plan 505.

In some examples, the instructions 104 may combine one or more of a first spatial representation (e.g., as determined via the instructions 103), a second spatial representation (e.g., as determined via the instructions 104), and a viewing plan (e.g., as determined via the instructions 104) to generate a spatial search volume (e.g., a volume of space that may be associated with one or more spatial representations). In some examples, the instructions 103-112 may utilize this spatial search volume to analyze information associated with a location and/or to determine a location (e.g., a location of a user device). More particularly, in some examples, an analysis to determine a location via the instructions 103-112 may primarily be based on information (e.g., data) related to an (associated) spatial search volume generated via the instructions 104.

So, in some examples and as shown in FIG. 1C, an intersection of the (first) spatial representation 503 and the (second) spatial representation 504 may produce a spatial search volume 506 (as indicated by the cross-hatched portion). Moreover, in some examples and as shown in FIG. 1C, the spatial search volume 506 may include an object, such as a landmark 507 that may be analyzed to determine a location. In some examples, the landmark 507 may include a sign 507a containing text that may be analyzed via the instructions 104 as well.

In some examples, the instructions 104 may analyze image information to determine a point-of-view (POV) associated with the received image information. In some examples, the instructions 104 may analyze the point-of-view (POV) associated with the captured image to determine an associated heading, which may be utilized by the instructions 104 to determine a location as well.

In some examples, the instructions 105 may receive sensor data. As used herein, “sensor data” may include any information that may be associated with a location to be determined. It may be appreciated that to receive the sensor data, the instructions 105 may also operate one or more sensors. So, in some examples and as illustrated in FIG. 1C, the instructions 105 may receive sensor data from sensors located on the user device 501 (e.g., via Wi-Fi transmission).

In some examples, the instructions 105 may receive inertial measurement unit (IMU) data. Examples of this data may relate to an object's specific force, an object's angular rate, and an object's orientation. In some examples, this information may be provided by an accelerometer, a gyroscope, and a magnetometer located on a user device (e.g., a smartphone). Examples of other sensors that may be implemented by the user device may include a pressure sensor, a piezometer, and a photodetector. It may be appreciated that information provided by any component of an electronic device (e.g., a sensor) may be implemented by the instructions 105, and may provide information associated with a location.

In some examples, information received from a magnetometer may be utilized to determine a heading (e.g., for an associated user device). Also, in some examples, the instructions 105 may receive and analyze “9-axis” inertial measurement unit (IMU) data to determine a location. In some examples, the 9-axis inertial measurement unit (IMU) data may include three-dimensional (3D) linear accelerometer data, three-dimensional (3-D) gyroscope/angular rate sensor data, and three-dimensional (3D) magnetometer data. In addition, in some examples, the instructions 105 may receive and analyze sensor data in conjunction with other data, such as global positioning system (GPS) data (e.g., as received via the instructions 103), to determine a location.

In some examples, the instructions 106 may provide a localization and mapping analysis. As will be discussed in further detail, the instructions 106 may utilize any information available via the instructions 103-112 to conduct a localization and mapping analysis for a location. As used herein, “localization” may include any activity or information associated with determining a location, and “mapping” may include any activity or information associated with determining an aspect or characteristic associated with a location.

In some examples, the instructions 106 may gather information (e.g., captured images) from a plurality of sources, and may utilize this information to build a database of mappings (e.g., located on the external system 200). An example of the plurality of sources may be a plurality of users of a social application using cameras on their user devices to capture images.

In some examples, to conduct a localization and mapping analysis, the instructions 106 may provide a simultaneous localization and mapping (SLAM) analysis. In some examples, in conducting the simultaneous localization and mapping (SLAM) analysis, the instructions 106 may utilize (among other things) one or more images associated with a location to construct a map of a location. In addition, in some examples, upon completing a map of a location (e.g., “closing of the loop”), the instructions 106 may utilize the constructed map to associate information (e.g., image information) received from a location (e.g., to be determined) to information (e.g., image information) for the mapped location. In addition, in some examples, to associate the information received with information of a previously mapped location, the instructions 106 may also utilize global navigation satellite system (GNSS) data, such as global positioning service (GPS) data (e.g., as received via the instructions 103).

In some examples, the instructions 107 may provide analysis of image information. As used herein, “image information” may include any data associated with a visual representation of a location, and “analysis of image information” may include any processing or analysis of any image data related to determining a location.

In some examples, analysis of image information by the instructions 107 may include analysis of text characters included in an image. For example, as discussed above, the landmark 507 illustrated in FIG. 1C may include the sign 507a. In some examples, the sign 507a may include the text “John's Burger Spot.” In some examples, a captured image of the sign 507a received via the instructions 107 may be analyzed to determine the text, and the determined text may be utilized to determine a location. More specifically, in some examples, the instructions 107 may compare locations of John's Burger Spot stores with global positioning system (GPS) data associated with the image to determine a location for the sign 507a (and the landmark 507).

In some examples, to provide image analysis, the instructions 107 may detect one or more features associated with an image. Examples of these features may include, but are not limited to, landmarks, structures (e.g., buildings) signs (e.g., road signs, commercial signs, etc.), and geographic landmarks (e.g., mountains).

In some examples, feature detection as implemented by the instructions 107 may include utilizing one or more designated features in an image. In some instances, these designated features in an image may be referred to as “markers.” In particular, in some examples, the instructions 107 may implement one or more artificial intelligence (AI) techniques to determine one or more features that may be particularly designated. In instances where the instructions 107 may implement artificial intelligence (AI) techniques to designate a marker, the marker may be referred to as an “artificial intelligence (AI) marker.”

So, in some examples, a plurality of users may utilize a social application to “tag” a particular feature in an image of a location. For example, while visiting Mount Rushmore, a plurality of users may repeatedly tag images of the faces of Mount Rushmore. In some examples, upon being repeatedly tagged by users, the instructions 107, implementing one or more artificial intelligence (AI) techniques, may associate an artificial intelligence (AI) marker with the faces of Mount Rushmore. As a result, in some examples, the instructions 107 may analyze an image to determine if the marked feature (e.g., the faces of Mount Rushmore) may be included, and if the marked feature may be included (e.g., discerned), the image may be associated with the (known) location (e.g., Mount Rushmore).

Accordingly, in some examples, the instructions 107 may utilize artificial intelligence (AI) markers to analyze identified features in an image and to associate the analyzed features with a marker for a predetermined location. In addition, by associating a feature in an analyzed image with a marker found in a previously analyzed (e.g., mapped) image, the instructions 107 may generate a particular (e.g., reduced) dataset of images, which may be associated with a corresponding number of particular (e.g., reduced) number of locations.

Therefore, it may be appreciated that in some examples, artificial intelligence (AI) markers may be utilized by the instructions 107 to analyze incoming images (e.g., in real time), and to efficiently “filter down” possible locations in order to generate an analyzed dataset of images that may correspond to probable locations. In some examples, the “filter down” process provided by the instructions 107 may be in conjunction with analysis of global navigation satellite system (GNSS) data (e.g., as provided via the instructions 103) and/or a localization and mapping analysis (e.g., as provided by the instructions 106).

In some examples, the instructions 108 may generate a candidate list of features. As used herein, a “candidate list” of features may include one or more features (e.g., associated with image information) of a location that may be used to determine the location. In some examples, to generate the candidate list of features, the instructions 108 may analyze one or more images associated with the location.

In some examples, the instructions 109 may generate an analyzed list of features. In particular, in some examples, the instructions 109 may utilize one or more techniques to filter one or more features (e.g., a candidate list of features generated via the instructions 108) associated with a location to generate a (smaller) subset of features that may be utilized to determine a location.

For example, in some examples, the instructions 109 may utilize various information, including but not limited to sensor data (e.g., 9-axis sensor data from an inertial measurement unit (IMU) as available via the instructions 105), to “filter down” a candidate list of features (e.g., as generated via the instructions 108). In addition, or in the alternative, in some examples, the instructions 109 may also utilize global positioning system (GPS) data (e.g., as available via the instructions 103), a heading (e.g., as available via the instructions 104), or a viewing plane (e.g., as available via the instructions 104) to “filter down” a candidate list of features and to generate the analyzed list of features.

In some examples, the instructions 110 may determine a landmark. As used herein, a “landmark” may include any physical entity, object, area, space or location that may be utilized to determine a location. In some examples, to determine a primary (e.g., significant) landmark, the instructions 110 may utilize various information available via the instructions 103-112. Examples of this information may include image information associated with a location (e.g., as provided via the instructions 104), sensor data associated with a location (e.g., as provided via the instructions 105), and an analyzed list of features associated with a location and sensor data (e.g., as provided via the instructions 109). In some examples, this information may be analyzed to determine a primary landmark, which may then be used (e.g., by the instructions 110) to analyze and determine an associated location.

In some examples, the instructions 111 may determine location information for a location. That is, in some examples, upon determining and analyzing the information gathered in the instructions 103-112, the instructions 111 may determine location information for a location. In some examples and as discussed above, this location information may be used to “tag” a content item associated with a location that a user may be located it.

As discussed above, examples of the information that may be analyzed may include image information associated with a location (e.g., as provided via the instructions 104), sensor data associated with a location (e.g., as provided via the instructions 105), and an analyzed list of features associated with a location and sensor data (e.g., as provided via the instructions 109). In some examples and for the reasons discussed herein, the determined location information may be more precise than a location that may be provided by, for example, (sole) use of global navigation satellite system (GNSS) data.

In some examples, the instructions 112 may transmit location information for a location to a user device. So, in an example where a user of a social application may wish to tag a captured image with location information, the instructions 112 may transmit the (determined) location information (e.g., as determined via the instructions 103-112) to the user's user device so that the user may tag the captured image.

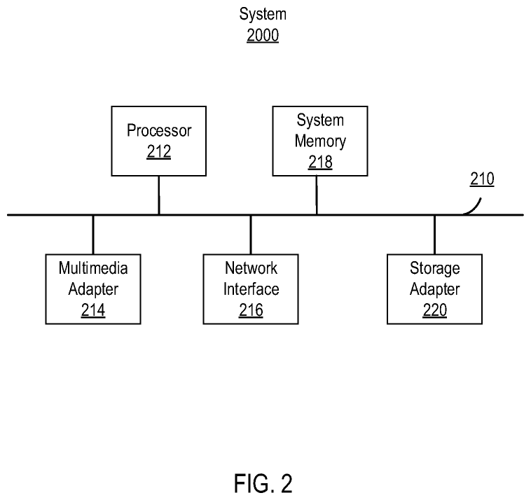

FIG. 2 illustrates a block diagram of a computer system for determining a location using a plurality of geo-location techniques, according to an example. In some examples, the system 2000 may be associated the system 100 to perform the functions and features described herein. The system 2000 may include, among other things, an interconnect 210, a processor 212, a multimedia adapter 214, a network interface 216, a system memory 218, and a storage adapter 220.

The interconnect 210 may interconnect various subsystems, elements, and/or components of the external system 200. As shown, the interconnect 210 may be an abstraction that may represent any one or more separate physical buses, point-to-point connections, or both, connected by appropriate bridges, adapters, or controllers. In some examples, the interconnect 210 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect 210 may allow data communication between the processor 212 and system memory 218, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 212 may be the central processing unit (CPU) of the computing device and may control overall operation of the computing device. In some examples, the processor 212 may accomplish this by executing software or firmware stored in system memory 218 or other data via the storage adapter 220. The processor 212 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 214 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 216 may provide the computing device with an ability to communicate with a variety of remote devices over a network (e.g., network 400 of FIG. 1A) and may include, for example, an Ethernet adapter, a Fibre Channel adapter, and/or other wired- or wireless-enabled adapter. The network interface 216 may provide a direct or indirect connection from one network element to another, and facilitate communication and between various network elements.

The storage adapter 220 may connect to a standard computer-readable medium for storage and/or retrieval of information, such as a fixed disk drive (internal or external).

Many other devices, components, elements, or subsystems (not shown) may be connected in a similar manner to the interconnect 210 or via a network (e.g., network 400 of FIG. 1A). Conversely, all of the devices shown in FIG. 9 need not be present to practice the present disclosure. The devices and subsystems can be interconnected in different ways from that shown in FIG. 9. Code to implement the dynamic approaches for payment gateway selection and payment transaction processing of the present disclosure may be stored in computer-readable storage media such as one or more of system memory 218 or other storage. Code to implement the dynamic approaches for payment gateway selection and payment transaction processing of the present disclosure may also be received via one or more interfaces and stored in memory. The operating system provided on system 100 may be MS-DOS, MS-WINDOWS, OS/2, OS X, IOS, ANDROID, UNIX, Linux, or another operating system.

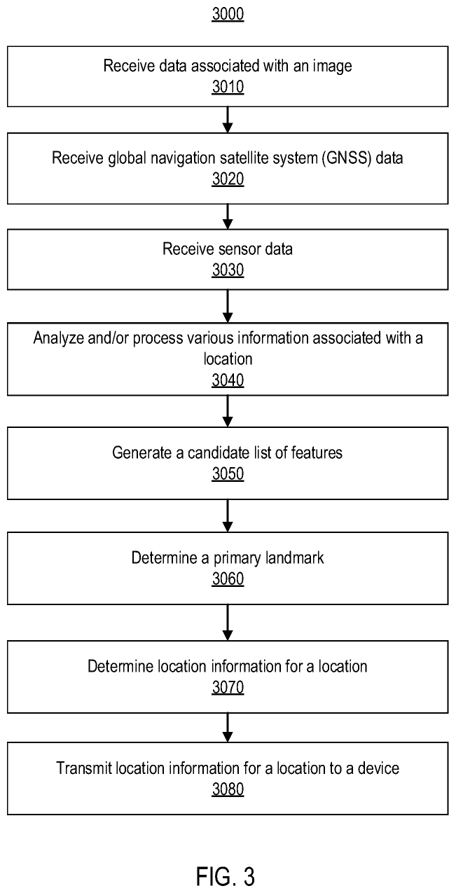

FIG. 3 illustrates a flow diagram of a method for a system, that may be implemented for determining a location using a plurality of geo-location techniques, according to an example. The method 3000 is provided by way of example, as there may be a variety of ways to carry out the method described herein. Each block shown in FIG. 3 may further represent one or more processes, methods, or subroutines, and one or more of the blocks may include machine-readable instructions stored on a non-transitory computer-readable medium and executed by a processor or other type of processing circuit to perform one or more operations described herein.

Although the method 3000 is primarily described as being performed by system 100 as shown in FIGS. 1A-1B, the method 3000 may be executed or otherwise performed by other systems, or a combination of systems. It should be appreciated that, in some examples, to provide determining a location using a plurality of geo-location techniques, the method 3000 may incorporate artificial intelligence (AI) or deep learning techniques, as described above. It should also be appreciated that, in some examples, the method 3000 may be implemented in conjunction with a content platform (e.g., a social media platform) to generate and deliver content.

Reference is now made with respect to FIG. 3. At 3010, the processor 101 may receive data associated with an image, wherein the image may be associated with a location. So, in an example where a user of a social application may have utilized a camera on a user device to capture an image (e.g., to be tagged), the processor 101 may receive the captured image transmitted from the user device.

At 3020, the processor 101 may receive global navigation satellite system (GNSS) data. In some examples, the global navigation satellite system (GNSS) data may be global positioning system (GPS) data. So, in the example where a user of a social application may have utilized a camera on a user device to capture an image, the processor 101 may also receive the global positioning system (GPS) data transmitted from a global positioning system (GPS) microchip located on the user device.

At 3030, the processor 101 may receive sensor data. So, in an example where a user of a social application may wish to tag an image captured by a user device, the processor 101 may receive the sensor data from one or more sensor devices on the user device. In some examples, the processor 101 may receive inertial measurement unit (IMU) data that may have been captured via an accelerometer, a gyroscope, and a magnetometer located on the user device.

At 3040, the processor 101 may analyze and/or process various information associated with a location. For example, in some instances, the processor 101 may analyze image information to identify one or more features (e.g., landmarks), and may compare any identified landmarks from the image information to a database of features (e.g., landmarks). In addition, in some examples, the processor 101 may analyze the image information to identify text characters, and may utilize the identified text characters to determine a location as well. Also, in some examples, the processor 101 may analyze the image information to identify one or more (e.g., previously-designated) markers, such as one or more artificial intelligence (AI) markers.

At 3050, the processor 101 may generate a candidate list of features. In some examples, to generate the candidate list of features, the processor 101 may analyze one or more images associated with the location to be determined to determine one or more identifiable and/or unique elements in the one or more images. Examples of such identifiable and/or unique elements include, but are not limited to, an object, a landmark, a structure, and a topology. Also, in some examples, the processor 101 may utilize one or more techniques to filter one or more features (e.g., a candidate list of features generated via the instructions 108) to generate a (smaller) subset of features that may be associated with a location. For example, in some examples, the processor 101 may utilize various information (e.g., any information associated with the instructions 103-112), such as sensor data and/or global positioning system (GPS) data, to “filter down” a candidate list of features.

At 3060, the processor 101 may determine a primary landmark. In some examples, the primary landmark determined be used to tag an associated location.

At 3070, the processor 101 may determine location information for a location. In some examples, this determined location may be more precise that a location that may be provided by, for example, mere use of global positioning system (GPS) data.

At 3080, processor 101 may transmit location information for a location to a device.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

It should be noted that the functionality described herein may be subject to one or more privacy policies, described below, enforced by the system 100, the external system 200, and the user devices 300A-300B that may bar use of images for concept detection, recommendation, generation, and analysis.

In particular examples, one or more objects of a computing system may be associated with one or more privacy settings. The one or more objects may be stored on or otherwise associated with any suitable computing system or application, such as, for example, the system 100, the external system 200, and the user devices 300A-300B, a social-networking application, a messaging application, a photo-sharing application, or any other suitable computing system or application. Although the examples discussed herein may be in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the system 100, the external system 200, and the user devices 300A-300B, or shared with other systems. Although this disclosure describes using particular privacy settings in a particular manner, this disclosure contemplates using any suitable privacy settings in any suitable manner.

In particular examples, the system 100, the external system 200, and the user devices 300A-300B may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the system 100, the external system 200, and the user devices 300A-300B may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular examples, different privacy settings may be provided for different user groups or user demographics.

In particular examples, the system 100, the external system 200, and the user devices 300A-300B may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the system 100, the external system 200, and the user devices 300A-300B may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt in or opt out of having objects or information accessed, stored, or used by specific applications or processes. The system 100, the external system 200, and the user devices 300A-300B may access such information in order to provide a particular function or service to the first user, without the system 100, the external system 200, and the user devices 300A-300B having access to that information for any other purposes. Before accessing, storing, or using such objects or information, the system 100, the external system 200, and the user devices 300A-300B may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the system 100, the external system 200, and the user devices 300A-300B.

In particular examples, a user may specify whether particular types of objects or information associated with the first user may be accessed, stored, or used by the system 100, the external system 200, and the user devices 300A-300B. As an example and not by way of limitation, the first user may specify that images sent by the first user through the system 100, the external system 200, and the user devices 300A-300B may not be stored by the system 100, the external system 200, and the user devices 300A-300B. As another example and not by way of limitation, a first user may specify that messages sent from the first user to a particular second user may not be stored by the system 100, the external system 200, and the user devices 300A-300B. As yet another example and not by way of limitation, a first user may specify that all objects sent via a particular application may be saved by the system 100, the external system 200, and the user devices 300A-300B.

In particular examples, privacy settings may allow a first user to specify whether particular objects or information associated with the first user may be accessed from the system 100, the external system 200, and the user devices 300A-300B. The privacy settings may allow the first user to opt in or opt out of having objects or information accessed from a particular device (e.g., the phone book on a user's smart phone), from a particular application (e.g., a messaging app), or from a particular system (e.g., an email server). The system 100, the external system 200, and the user devices 300A-300B may provide default privacy settings with respect to each device, system, or application, and/or the first user may be prompted to specify a particular privacy setting for each context. As an example and not by way of limitation, the first user may utilize a location-services feature of the system 100, the external system 200, and the user devices 300A-300B to provide recommendations for restaurants or other places in proximity to the user. The first user's default privacy settings may specify that the system 100, the external system 200, and the user devices 300A-300B may use location information provided from one of the user devices 300A-300B of the first user to provide the location-based services, but that the system 100, the external system 200, and the user devices 300A-300B may not store the location information of the first user or provide it to any external system. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. The system 100, the external system 200, and the user devices 300A-300B may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the system 100, the external system 200, and the user devices 300A-300B may use a user's previous activities and calculated moods, emotions, or sentiments to determine a present mood, emotion, or sentiment. A user who wishes to enable this functionality may indicate in their privacy settings that they opt in to the system 100, the external system 200, and the user devices 300A-300B receiving the inputs necessary to determine the mood, emotion, or sentiment. As an example and not by way of limitation, the system 100, the external system 200, and the user devices 300A-300B may determine that a default privacy setting is to not receive any information necessary for determining mood, emotion, or sentiment until there is an express indication from a user that the system 100, the external system 200, and the user devices 300A-300B may do so. By contrast, if a user does not opt in to the system 100, the external system 200, and the user devices 300A-300B receiving these inputs (or affirmatively opts out of the system 100, the external system 200, and the user devices 300A-300B receiving these inputs), the system 100, the external system 200, and the user devices 300A-300B may be prevented from receiving, collecting, logging, or storing these inputs or any information associated with these inputs. In particular examples, the system 100, the external system 200, and the user devices 300A-300B may use the predicted mood, emotion, or sentiment to provide recommendations or advertisements to the user. In particular examples, if a user desires to make use of this function for specific purposes or applications, additional privacy settings may be specified by the user to opt in to using the mood, emotion, or sentiment information for the specific purposes or applications. As an example and not by way of limitation, the system 100, the external system 200, and the user devices 300A-300B may use the user's mood, emotion, or sentiment to provide newsfeed items, pages, friends, or advertisements to a user. The user may specify in their privacy settings that the system 100, the external system 200, and the user devices 300A-300B may determine the user's mood, emotion, or sentiment. The user may then be asked to provide additional privacy settings to indicate the purposes for which the user's mood, emotion, or sentiment may be used. The user may indicate that the system 100, the external system 200, and the user devices 300A-300B may use his or her mood, emotion, or sentiment to provide newsfeed content and recommend pages, but not for recommending friends or advertisements. The system 100, the external system 200, and the user devices 300A-300B may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the system 100, the external system 200, and the user devices 300A-300B may be restricted in its access, storage, or use of the objects or information. The system 100, the external system 200, and the user devices 300A-300B may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the system 100, the external system 200, and the user devices 300A-300B may temporarily store the message in a content data store until the second user has viewed or downloaded the message, at which point the system 100, the external system 200, and the user devices 300A-300B may delete the message from the data store. As another example and not by way of limitation, continuing with the prior example, the message may be stored for a specified period of time (e.g., 2 weeks), after which point the system 100, the external system 200, and the user devices 300A-300B may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the system 100, the external system 200, and the user devices 300A-300B may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the system 100, the external system 200, and the user devices 300A-300B. The user's privacy settings may specify that such information may be used only for particular processes, such as authentication, and further specify that such information may not be shared with any external system or used for other processes or applications associated with the system 100, the external system 200, and the user devices 300A-300B. As another example and not by way of limitation, the system 100, the external system 200, and the user devices 300A-300B may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the system 100, the external system 200, and the user devices 300A-300B. As another example and not by way of limitation, the system 100, the external system 200, and the user devices 300A-300B may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the system 100, the external system 200, and the user devices 300A-300B.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The system 100, the external system 200, and the user devices 300A-300B may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the system 100, the external system 200, and the user devices 300A-300B may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the system 100, the external system 200, and the user devices 300A-300B may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the system 100, the external system 200, and the user devices 300A-300B may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (e.g., “public”). However, if the user changes his or her relationship status, the system 100, the external system 200, and the user devices 300A-300B may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the system 100, the external system 200, and the user devices 300A-300B may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the system 100, the external system 200, and the user devices 300A-300B may send a reminder to the user to confirm his or her privacy settings every six months or after every ten photo posts. In particular examples, privacy settings may also allow users to control access to the objects or information on a per-request basis. As an example and not by way of limitation, the system 100, the external system 200, and the user devices 300A-300B may notify the user whenever an external system attempts to access information associated with the user, and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A system, comprising:
a processor; and
a memory storing instructions, which when executed by the processor, cause the processor to:
receive global navigation satellite system (GNSS) data associated with a location;
receive sensor data associated with the location;
receive image information associated with the location;
analyze the image information associated with the location;
provide a localization and mapping analysis for the location;
determine an analyzed list of features and a primary landmark associated with the location; and
determine location information for the location based on the analyzed list of features and the primary landmark.

2. The system of claim 1, wherein the global navigation satellite system (GNSS) data is global positioning system (GPS) data.

3. The system of claim 1, wherein the instructions, which when executed by the processor, cause the processor to determine a point-of-view (POV) associated with the image information.

4. The system of claim 1, wherein the sensor data comprises inertial measurement unit (IMU) data.

5. The system of claim 1, wherein the instructions, which when executed by the processor, cause the processor to provide a simultaneous localization and mapping (SLAM) analysis.

6. The system of claim 1, wherein the instructions, which when executed by the processor, cause the processor to analyze text characters associated with the image information.

7. The system of claim 1, wherein the instructions, which when executed by the processor, cause the processor to generate a candidate list of features associated with the location.

8. A method of determining a location using a plurality of geo-location techniques, comprising:
receiving global navigation satellite system (GNSS) data associated with the location;
receiving sensor data associated with the location;
receiving image information associated with the location;
analyzing the image information associated with the location;
providing a localization and mapping analysis for the location;
determining an analyzed list of features and a primary landmark associated with the location; and
determining location information for the location based on the analyzed list of features and the primary landmark.

9. The method of claim 8, wherein the global navigation satellite system (GNSS) data is global positioning system (GPS) data.

10. The method of claim 8, further comprising determining a point-of-view (POV) associated with the image information.

11. The method of claim 8, further comprising providing a simultaneous localization and mapping (SLAM) analysis.

12. The method of claim 8, wherein the sensor data comprises inertial measurement unit (IMU) data.

13. The method of claim 12, wherein the inertial measurement unit (IMU) data comprises data from a magnetometer.

14. The method of claim 8, further comprising generating a candidate list of features associated with the location.

15. A non-transitory computer-readable storage medium having an executable stored thereon, which when executed instructs a processor to:
receive global navigation satellite system (GNSS) data associated with a location;
receive sensor data associated with the location;
receive image information associated with the location;
analyze the image information associated with the location;
provide a localization and mapping analysis for the location;
determine an analyzed list of features and a primary landmark associated with the location; and
determine location information for the location based on the analyzed list of features and the primary landmark.

16. The non-transitory computer-readable storage medium of claim 15, wherein the executable when executed further instructs the processor to determine a point-of-view (POV) associated with the image information.

17. The non-transitory computer-readable storage medium of claim 15, wherein the executable when executed further instructs the processor to provide a simultaneous localization and mapping (SLAM) analysis.

18. The non-transitory computer-readable storage medium of claim 15, wherein the executable when executed further instructs the processor to analyze text characters associated with the image information.

19. The non-transitory computer-readable storage medium of claim 15, wherein the global navigation satellite system (GNSS) data is global positioning system (GPS) data.

20. The non-transitory computer-readable storage medium of claim 15, wherein the sensor data comprises inertial measurement unit (IMU) data.
